(19) United States
(12) Patent Application Publication
(10) Pub. No.: US 2021/0025248 A1
(43) Pub. Date: Jan. 28, 2021

(54) CENTRALIZER

(71) Applicant: Weatherford Technology Holdings, LLC, Houston, TX (US)

(72) Inventors: Sebastian F. KRIEGER, Hannover (DE); Christian KIESS, Hannover (DE)

(21) Appl. No.: 16/523,616

(22) Filed: Jul. 26, 2019

(51) Int. Cl. E21B 17/10; B23K 31/02

(52) U.S. Cl. CPC E21B 17/1078; B23K 2101/08; B23K 31/02

(57) ABSTRACT

A method of manufacturing a centralizer having a plurality of blades includes cutting the plurality of blades from a metal sheet; hardening the plurality of blades using a heat treatment process; and welding the plurality of blades to a tubular body. The blades may be welded to the tubular body using a plurality of weld seams.

### BACKGROUND

### Field

Embodiments of the present disclosure generally relate to a centralizer for use in wellbore operations.

### Description of the Related Art

A wellbore is formed to access hydrocarbon bearing formations, such as crude oil and/or natural gas, by the use of drilling. Drilling is accomplished by utilizing a drill bit that is mounted on the end of a drill string. To drill within the wellbore to a predetermined depth, the drill string is often rotated by a top drive or rotary table on a surface platform or rig, and/or by a downhole motor mounted towards the lower end of the drill string. After drilling to a predetermined depth, the drill string and drill bit are removed and a casing string is lowered into the wellbore. An annulus is formed between the string of casing and the wellbore. The casing string is cemented into the wellbore by circulating cement slurry into the annulus. The combination of cement and casing strengthens the wellbore and facilitates the isolation of certain formations behind the casing for the production of hydrocarbons.

Centralizers are mounted on the casing string to center the casing string in the wellbore and obtain a uniform thickness cement sheath around the casing string. Each centralizer has blades extending out from the casing wall and contacting the wellbore. The centralizers hold the casing string off of direct contact with the wellbore wall, and substantially centralize the casing therein. To accomplish that goal, the centralizer blades typically form a total centralizer diameter roughly the diameter of the wellbore in which the casing string is run.

One type of centralizer is rigid including a solid central tubular body having a plurality of solid blades integral with the central body. The blades extend out to the desired diameter. Another type is a bow spring centralizer, which includes a pair of spaced-apart bands locked into place on the casing. Resilient bow spring blades are spaced around the circumference of the bands and connects the two bands to each other. The bow spring centralizers are capable of at least partially collapsing as the casing string is run into the wellbore to pass through a restricted diameter location, such as a piece of equipment having an inner diameter smaller than the at-rest bow spring diameter, and then springing back out after passage through the restricted diameter location.

In some instances, such as during a drilling operation, the centralizer experiences extensive side loads and shows extensive wear.

There is a need, therefore, for a centralizer having wear resistant blades and capable of withstanding a high axial load.

### SUMMARY

In one embodiment, a method of manufacturing a centralizer having a plurality of blades includes cutting the plurality of blades from a metal sheet; hardening the plurality of blades using a heat treatment process; and welding the plurality of blades to a tubular body.

In another embodiment, a centralizer includes a body having a bore therethrough; and a plurality of hollow blades attached to the body, wherein a plurality of weld seams is used to attach each blade to the body.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a schematic view of a centralizer disposed on a tubular in accordance with one embodiment.

FIG. 2 is a perspective view of an exemplary embodiment of a centralizer.

FIG. 3 is a side view of the centralizer of FIG. 2.

FIG. 4 is a cross-sectional view of the centralizer of FIG. 2.

FIG. 5 is a side view of another exemplary embodiment of a centralizer.

FIG. 6 is a cross-sectional view of the centralizer of FIG. 5.

FIG. 7 shows an example of a non-heat treated blade attached to a body.

FIG. 8 shows a first example of a heat treated blade attached to a body.

FIG. 9 shows a second example of a heat treated blade attached to a body.

FIG. 10 shows a third example of a heat treated blade attached to a body.

FIG. 11 shows a fourth example of a heat treated blade attached to a body.

FIG. 12 shows the effect of blade hardness on the collapse force.

FIG. 13 shows the effect of weld seam length on the collapse force.

### DETAILED DESCRIPTION

Embodiments of the present disclosure provide a centralizer having increased hardness. The centralizers are more resistant to wear and collapse.

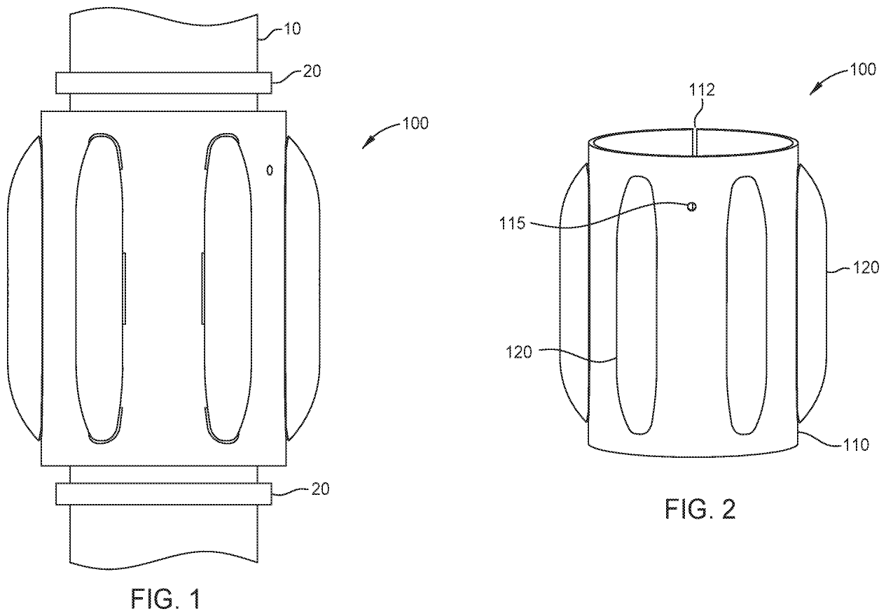

FIG. 1 illustrates a perspective view of an exemplary centralizer 100 disposed on a tubular 10, such as casing or drill pipe. The centralizer 100 is positioned on the tubular 10 between two stop collars 20, which may be attached to the tubular 10. The centralizer 100 is rotatable relative to the tubular 10 and axially movable relative to the tubular 10 between the stop collars 20. The stop collars 20 limit axial movement of the centralizer 100 along the tubular 10.

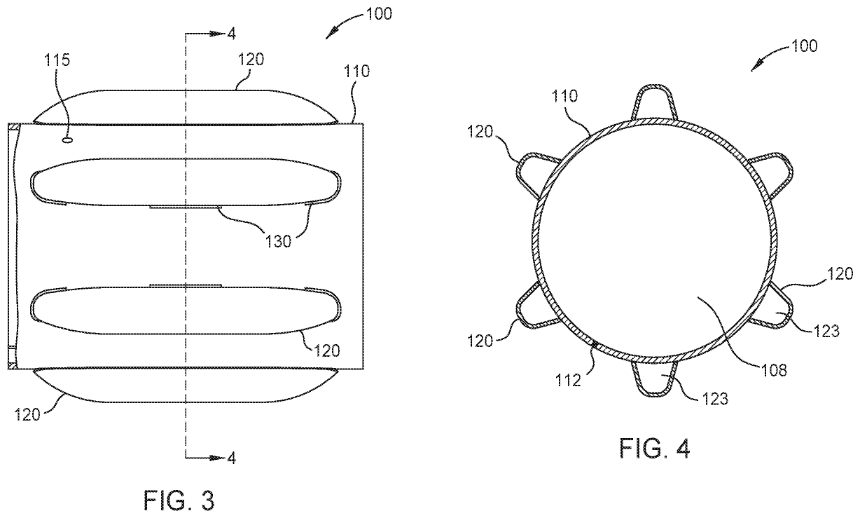

FIG. 2 is a perspective view of the centralizer 100, according to one embodiment. FIG. 3 is a side view of the centralizer 100, and FIG. 4 is a cross-sectional view of the centralizer 100. The centralizer 100 includes a tubular body 110 having a bore 108 extending therethrough. The inner diameter of the centralizer 100 is sufficiently larger than the outer diameter of the tubular 100 so the centralizer 100 can rotate and axially move relative to the tubular 10. The tubular body 110 may be manufactured from a ferrous containing material, such as a steel alloy. In one embodiment, the tubular body 110 is cut from a flat sheet of steel to a desired length. The steel sheet is then rolled into a tubular shape and welded together. The weld seam 112 is shown in FIGS. 2 and 4. In one embodiment, an optional pressure relief port 115 or valve is formed in the tubular body 110.

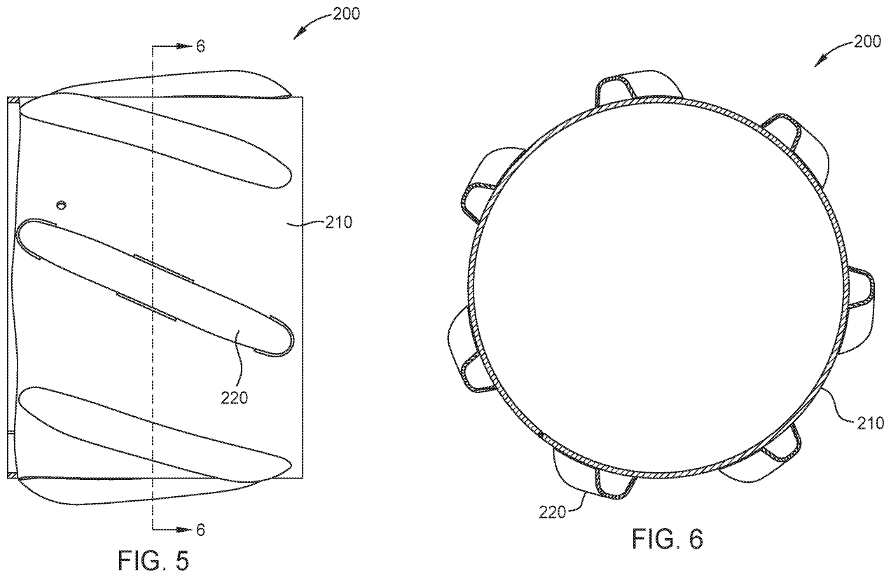

The centralizer 100 includes a plurality of blades 120 disposed on the exterior surface of the tubular body 110. Any suitable number of blades 120 may disposed on the tubular body 110, such as two, three, four, five, six, eight, ten, or more blades 120. As shown in FIG. 4, six blades 120 are disposed circumferentially on the tubular body 110. The blades 120 may be attached to the tubular body 110 by welding. In one embodiment, the blades 120 have a hollow core 123, as shown in FIG. 4. In one example, the blades 120 are cut from a flat sheet of steel alloy material to a desired size. The cut sheet is placed into a forming tool having a mold of the desired shape of the blades 120. Then, the cut sheet is mechanically pressed by the forming tool to form the hollow blade shape. FIG. 1 shows an exemplary centralizer with hollow blades 120. FIG. 1 shows the blades 120 aligned in the axial direction of the tubular body 110. It is contemplated the blades 120 may be positioned at an angle relative to the central axis of the tubular body 110. For example, the blades 120 may be positioned between 1° and 40° relative to the central axis. As shown in FIGS. 5 and 6, the blades 220 of the centralizer 200 are positioned at an angle of 24° relative to the central axis of the tubular body 210.

In one embodiment, the blades 120 are made from a steel alloy material that is heat treatable. In one aspect, the blades 120 are made from a steel alloy material having a carbon equivalent content (“CE”) in a range from 0.2 to 0.6. The carbon equivalent content can be determined by using the Dearden and O'Neill formula adopted by the International Institute of Welding, as shown below:

$$CE = \% C + \frac{\% Mn}{6} + \frac{\% Cr + \% Mo + \% V}{5} + \frac{\% Cu + \% Ni}{15}$$

Suitable examples of the steel alloy material include, but are not limited to, 35MnB5, 25CrMo4, 42CrMo4, 26MnB5, and 34MnB5.

In one aspect, the strength of the blades 120 can be adjusted by heat treating the blades 120. In one embodiment, the heat treatment includes quenching the blade and, optionally, tempering the blade. In general, quenching increases the hardness of the blade, and tempering increases the toughness of the blade, which decreases the hardness of the blades. The quenching process may begin by heating the blade to a temperature between 760° C. and 930° C., such as between 815° C. and 900° C., for a time period between 60 and 90 minutes. In one example, during the quenching process, the blade is heated to a temperature between 760° C. and 850° C. In another example, during the quenching process, the blade is heated to a temperature between 850° C. and 930° C. Then the blade 120 is cooled by immersing the blade 120 in a quenching fluid such as water or oil. For example, the blade 120 can be quenched in oil at temperature between 60° C. and 90° C. In one embodiment, the hardness of the blade after quenching may be in a range between 46-50 HRC.

If the resulting heat treated blade 120 has a hardness that is higher than the target hardness, then the tempering process can be performed to reduce the hardness. In one example, to temper blade, the blade 120 is heated to a temperature between 350° C. and 420° C. for a time period between 60 minutes and 120 minutes. In one embodiment, the tempered blade has a hardness in a range from 40 HRC to 44 HRC. The heat treated blades 120 has increased strength to resist collapse and increased wear resistance.

In one aspect, the collapse force of the blades 120 can be adjusted by controlling the weld seam length attaching the blades 120 to the body 110. In one embodiment, the entire perimeter of the blade 120 is welded to the tubular body 110 using a continuous seam, i.e., a single seam with no gaps along the perimeter. In another embodiment, a plurality of the weld seams 130 are used to attach the blade 120 to the body 110. One end of each seam 130 is spaced from an end of an adjacent seam 130. Referring to the example shown in FIG. 3, four seams 130 are used to attach the blade 120 to the tubular body 110. While four seams 130 are used in this example, any suitable number of seams 130 may be used; for example, two, three, five, six, eight, ten or more seams may be used. Each seam 130 may have the same or different length. For example, each seam 130 can have the same length. In another example, the seams 130 can have a different length. In yet another example, some of the seams 130 can have the same length, and other seams 130 can have a different length. While without wishing to be bound by theory, it is believed the collapse force may be adjusted based on the sum of the lengths of the seams 130 and the position of the seams 130. In one aspect, the sum of the lengths of two or more seams is from 30% to 95% to the length of the perimeter of the blade 120. In one embodiment, a combination of heat treatment and weld seam length is used to adjust the collapse force of the centralizer.

### EXAMPLES

FIG. 8 shows an example of a blade attached to a body. The blade is manufactured from a steel alloy material; specifically, 25CrMo4. The blade was heat treated to increase its hardness to 43 HRC. In particular, the blade was austenitized at a temperature of about 860° C. for 90 minutes and then quenched in oil at 80° C. Thereafter, the blade 120 was tempered by heating the blade to a temperature of 380° C. for a time period of 70 minutes. The blade was circumferentially welded to the body using a single seam.

FIG. 9 shows another example of a blade attached to the body. The blade is manufactured from a steel alloy material; specifically, 25CrMo4. The blade was heat treated to increase its hardness to 48 HRC. In particular, the blade was austenitized at a temperature of about 860° C. for 90 minutes and then quenched in oil at 80° C. The blade 120 was not subsequently tempered. The blade was circumferentially welded to the body using a single seam.

FIG. 10 shows another example of a blade attached to a body. The blade is manufactured from a steel alloy material; specifically, 25CrMo4. The hardness of the blade was increased to 43 HRC using the heat treatment process described above for FIG. 8. The blade was welded to the body using four seams. The seams at the ends of the blade have a length of 25 mm, and the two seams in the middle of the blade have a length of 40 mm for a total length of 130 mm.

FIG. 11 shows another example of a blade attached to a body. The blade is manufactured from a steel alloy material; specifically, 25CrMo4. The hardness of the blade was increased to 43 HRC using the heat treatment process described above for FIG. 8. The blade was welded to the body using four seams. The seams at the ends of the blade have a length of 30 mm, and the two seams in the middle of the blade have a length of 60 mm for a total length of 180 mm.

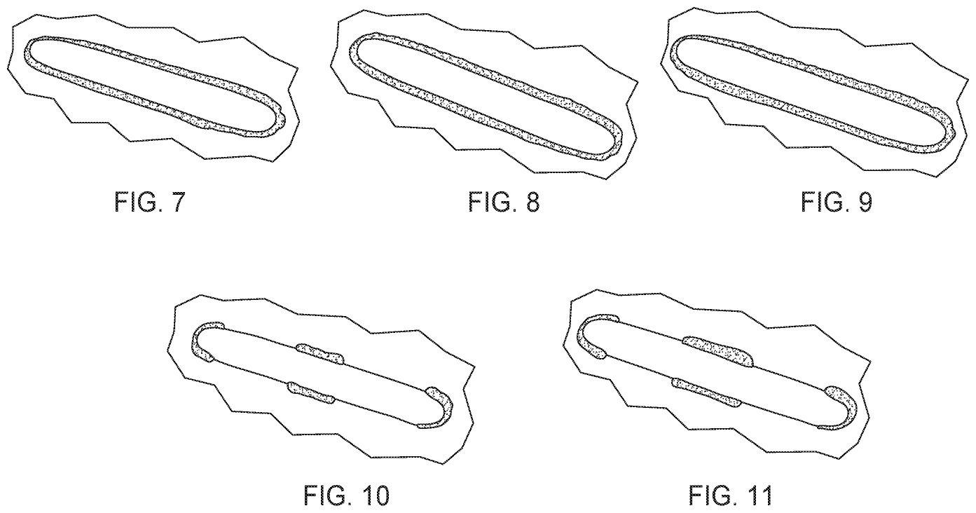

FIG. 7 shows an example of a blade attached to a body. The blade is manufactured from a steel alloy material; specifically, 25CrMo4. The blade was not heat treated and retains its original hardness of 156 HB. The blade was circumferentially welded to the body using a single seam.

Comparison

The blades were tested to determine the influence of blade hardness and the influence of weld seam length on the collapse force. The collapse force is defined as the force needed to reduce the outer diameter of the centralizer sufficiently to still deliver a 67% standoff. Standoff is an indication of eccentricity and is defined by the following formula:

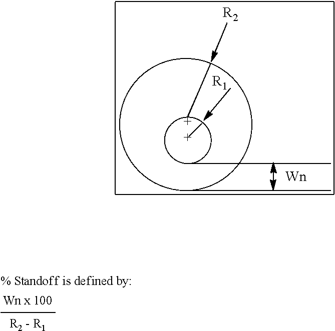

The result of this formula is given as a percentage, where 0% represents the tubular is in contact with the outer wall and 100% represents perfectly a centered tubular.

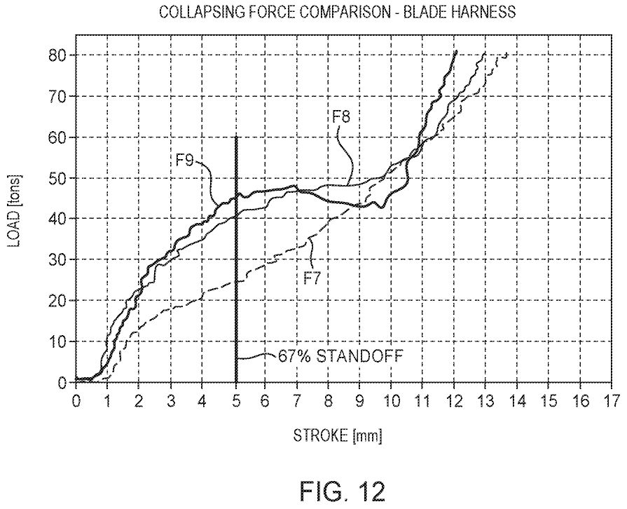

FIG. 12 shows the effect of blade hardness on the collapse force. In particular, the effect of hardness on the collapse force was compared for the blades shown in FIGS. 7-9. The heat treated blades of FIGS. 8 and 9 have a hardness of 43 HRC and 48 HRC, respectively. Each of the three blades was circumferentially welded to the body using a single seam. The results of the collapse test for the blades of FIGS. 7-9 are indicated by lines F7-F9, respectively. It can be seen that the heat treated blades of F8 and F9 can withstand a much higher force than the non-heat treated blade of F7 before reaching 67% standoff. Specifically, the collapse force for the heat treated blades F8 and F9 are 41.6 metric tons and 45.8 metric tons, respectively. The collapse force for the untreated blade F7 is 24.6 metric tons. In addition, the blade of FIG. 9, being harder, can withstand a slight higher force than FIG. 8 before reaching 67% standoff.

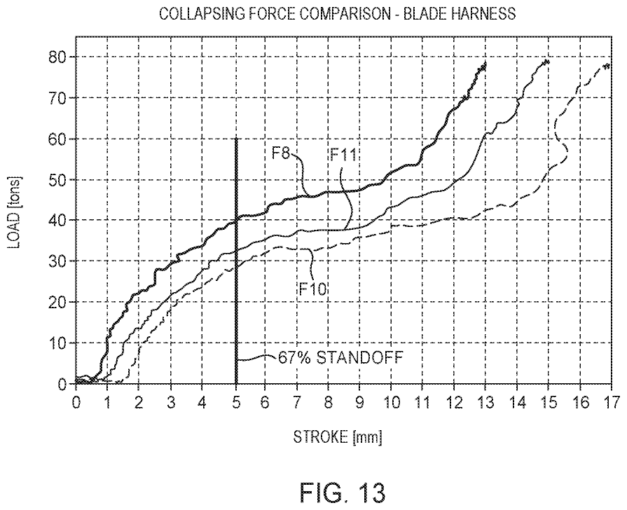

FIG. 13 shows the effect of weld seam length on the collapse force. In particular, the effect of weld seam length on the collapse force was compared for the blades shown in FIGS. 8, 10, and 11. The blade of FIG. 8 was circumferentially welded using a single seam, and thus has the longest weld seam length. The blade of FIG. 10 was welded to the body using four seams, which have a total length of 130 mm. The blade of FIG. 11 was welded to the body using four seams, which have a total length of 180 mm. All three blades have the same hardness of 43 HRC. The results of the collapse test for the blades of FIGS. 8, 10, and 11 are indicated by lines F8, F10, and F11, respectively. It can be seen from FIG. 13 that the longer weld seam length of F8 can withstand a higher collapse force than shorter weld seam lengths of F10 and F11 before reaching 67% standoff. Specifically, the collapse force for the circumferentially welded blade F8 is 41.6 metric tons, while the collapse force for blades F10 and F11 are 29.4 metric tons and 33.6 metric tons, respectively.

In one embodiment, a method of manufacturing a centralizer having a plurality of blades includes cutting the plurality of blades from a metal sheet; hardening the plurality of blades using a heat treatment process; and welding the plurality of blades to a tubular body.

In one or more of the embodiments described herein, the plurality of blades comprise a hollow blade.

In one or more of the embodiments described herein, hardening the plurality of blades comprises using a first heat treatment to increase the plurality of blades to a first hardness.

In one or more of the embodiments described herein, hardening the plurality of blades comprises using a second heat treatment to decrease the plurality of blades to a second hardness.

In one or more of the embodiments described herein, welding the plurality of blades comprises using a plurality of spaced apart weld seams to attach each blade to the tubular body.

In one or more of the embodiments described herein, the method includes adjusting a collapse force of the plurality of blades by using a plurality of spaced apart weld seams to attach each blade to the tubular body.

In one or more of the embodiments described herein, the plurality of blades comprise a steel alloy material having a carbon equivalent content in a range from 0.2 to 0.6.

In one or more of the embodiments described herein, the plurality of blades comprise a hollow blade.

In one or more of the embodiments described herein, the method includes mechanically forming the cut metal sheet into a hollow blade.

In one or more of the embodiments described herein, the method includes cutting the tubular body is cut from a second metal sheet and rolling the cut second metal sheet into a tubular shape.

In another embodiment, a centralizer includes a body having a bore therethrough; and a plurality of hollow blades attached to the body, wherein a plurality of weld seams is used to attach each blade to the body.

In one or more of the embodiments described herein, the plurality of hollow blades comprises a steel alloy material having a carbon equivalent content from 0.2 to 0.6.

In one or more of the embodiments described herein, the plurality of hollow blades were heat treated to change a hardness of the plurality of hollow blades.

In one or more of the embodiments described herein, the body is made of the same steel alloy material as the plurality of blades.

In one or more of the embodiments described herein, the plurality of hollow blades are positioned at an angle relative to a central axis of the body.

While the foregoing is directed to embodiments of the present disclosure, other and further embodiments of the disclosure may be devised without departing from the basic scope thereof, and the scope thereof is determined by the claims that follow.

1. A method of manufacturing a centralizer having a plurality of blades comprising:
cutting the plurality of blades from a metal sheet;
hardening the plurality of blades using a heat treatment process; and
welding the plurality of blades to a tubular body.

2. The method of claim 1, wherein the plurality of blades comprise a hollow blade.

3. The method of claim 1, wherein hardening the plurality of blades comprises using a first heat treatment to increase the plurality of blades to a first hardness.

4. The method of claim 3, wherein hardening the plurality of blades comprises using a second heat treatment to decrease the plurality of blades to a second hardness.

5. The method of claim 1, wherein welding the plurality of blades comprises using a plurality of spaced apart weld seams to attach each blade to the tubular body.

6. The method of claim 5, further comprising adjusting a collapse force of the plurality of blades by using a plurality of spaced apart weld seams to attach each blade to the tubular body.

7. The method of claim 6, wherein the plurality of blades comprise a steel alloy material having a carbon equivalent content in a range from 0.2 to 0.6.

8. The method of claim 7, wherein the plurality of blades comprise a hollow blade.

9. The method of claim 1, wherein the plurality of blades comprise a steel alloy material having a carbon equivalent content in a range from 0.2 to 0.6.

10. The method of claim 1, further comprising mechanically forming the cut metal sheet into a hollow blade.

11. The method of claim 1, further comprising cutting the tubular body is cut from a second metal sheet and rolling the cut second metal sheet into a tubular shape.

12. A centralizer, comprising:
a body having a bore therethrough; and
a plurality of hollow blades attached to the body, wherein a plurality of weld seams is used to attach each blade to the body.

13. The centralizer of claim 12, wherein the plurality of hollow blades comprises a steel alloy material having a carbon equivalent content from 0.2 to 0.6.

14. The centralizer of claim 13, wherein the plurality of hollow blades were heat treated to change a hardness of the plurality of hollow blades.

15. The centralizer of claim 13, wherein the body is made of the same steel alloy material as the plurality of blades.

16. The centralizer of claim 12, wherein the plurality of hollow blades is positioned at an angle relative to a central axis of the body.
